(19) United States
(12) Patent Application Publication
(10) Pub. No.: US 2017/0095726 A1
(43) Pub. Date: Apr. 6, 2017

(54) CARD GAME WITH SUPPLEMENTARY BETTING OPTION

(71) Applicant: Cory DAVIS, Alexandria (AU)

(72) Inventor: Rowland THOMAS, Rose Bay (AU)

(21) Appl. No.: 15/209,362

(22) Filed: Jul. 13, 2016

Related U.S. Application Data
(63) Continuation of application No. 14/390,203, filed on Oct. 2, 2014, now abandoned.

(30) Foreign Application Priority Data
Apr. 3, 2012 (AU) 2012901316

(51) Int. Cl. A63F 1/00; G07F 17/32

(52) U.S. Cl. CPC A63F 1/00; G07F 17/3288; G07F 17/3293; A63F 2001/001; A63F 2001/003

(57) ABSTRACT

A card game in which a player or banker is dealt a first hand formed from at least two cards, wherein the banker or player can make a wager on the first hand before the hands are dealt; dealing at least a third card for each of said player and banker hands to form a new hand on which a player is able to place a bet/wager during game play on the effect of said third card dealt irrespective of whether or not the player wagered on said first hands.

### CROSS-REFERENCE TO RELATED APPLICATION

This application is a continuation of U.S. patent application Ser. No. 14/390,203, filed Oct. 2, 2014, herein incorporated by reference.

### BACKGROUND

The present invention relates to manual or electronic card games of chance and more particularly relates to a card game feature whereby a player can play a primary game and exercise bet options on a secondary or auxiliary game either separate from the primary game or in cooperation with the primary game. The present invention also relates to an alternative to the known bet option on card games including black jack and baccarat games and which provides increased betting options and an increase actual or perceived opportunities for a win. The invention also relates to gaming card games of chance in which a player is provided with an increased opportunity to bet during a primary game of chance. More particularly the invention relates to improvements in wagering on card games such as baccarat and black jack irrespective of whether those or other card games are presented in casinos as table games or electronically on line. The invention relates to providing increased betting options for card games in real or electronic form.

### PRIOR ART

There are already in existence a wide variety of betting option in games of chance including gaming games for use in table, slot and gaming machines. In order to achieve an edge over competitors, gaming operators and designers are constantly seeking and providing special game features in the hope of attracting player interest and which provide players with novel alternatives. In gaming, it is usually those features associated with jackpots or a perceived or actual increased probability of winning which are likely to attract player interest. A typical table or electronic game display will include indicia for the benefit of the player relating to the number of bet options, credits the payer has, the amount wagered and periodic instructions which tell the player what the status of play is or what the player is to do next. In some cases the player may be aware of likely odds of securing a win but for the most part odds are known only by the gaming house such as casinos.

Within this framework game providers have sought ways to make games more attractive to the player which ensure that player interest will be maintained largely founded on an increased perception of a win or an increased actual chance of a win. Gaming is often considered by participants as more about entertainment than and expectation of large returns on bets. A conventional gaming machine for instance is programmed to award a player an average of 15 free games where pays are usually multiplied by a factor. This is an unofficial industry standard for a successful game. For example, a game with 15 free games will have a hit rate of between 7 and 12. Therefore in its lifetime, at best, on average, 2 spins in 15 will pay.

Table gaming games found in casinos and the like are also adaptable in electronic form. Some card games can be played on line allowing for betting on outcomes. In order to achieve an edge over competitors, casino operators gaming machine producers and totalisator betting agencies provide special game or betting features in the hope of attracting player interest and which provide players with novel alternatives. In gaming, it is usually those features associated a perceived or actual increased probability of winning which are likely to attract player interest. The player typically does not have control over the jackpots or trigger conditions for feature game play.

It is known for a gaming machine to typically include both a main or primary display for displaying the outcome of a primary game and a secondary display for presenting primary, secondary, or even “tertiary information.” Tertiary information refers to information that is not directly related to the play of a primary or secondary game. Regardless of where the video display is located and how much space it occupies, it may introduce substantial flexibility in presenting primary and secondary information to actual and potential players.

In land based gaming hardware there exist options for players to bet on supplementary games within a primary game. This is intended to make games more attractive for players and which ensure that player interest will be maintained. Gaming hardware and software is designed to accommodate changes to the game content and presentation. A primary display may present various player attraction materials according to game software included in the game controller.

Secondary game events have been provided as a variation to a primary game on some gaming machines and might include a bonus feature. Feature games are played when a trigger is activated usually in a main game. In the known game features, the player has no control over the timing of the feature and a players luck becomes completely dependent upon the next few spins. Known game features are activated randomly and the player does not know when the game feature will be available nor what the criteria are to initiate the feature. These outcomes are normally determined by a game controller within the machine.

Primary game information includes, for example, information about stages of game play such as a currency in stage in which the machine awaits a coin or bill insertion to initiate a play, a game play stage in which the player has initiated a play (e.g., spinning reels on a slot machine), and a game result stage in which a payout or no-payout event is registered. Secondary game information includes information about progressive games, bonusing schemes, and other incentives for maintaining a player's interest or to play in a particular manner.

Primary and secondary game displays with which a player can interact are known. U.S. Pat. No. 6,315,666 for instance, discloses a typical gaming machine having a single gaming machine controller with a main display controlled electronically by a gaming machine controller, which presents the results of a play on the gaming machine. A secondary display may be provided at various locations on the gaming machine.

The gaming machine controller; controls the outcome of a bonus game and presents the results of the play on the main display of the gaming machine; and controls display of video content associated with the bonus game on the secondary display with the slave processing system. Although secondary games are known in gaming machines, there has not been an analogous regime applied to card games. Table card games have remained largely the same for many years with the long known betting options presented to players.

There has been a long felt want in the industry to provide a more versatile table gaming games and more particularly card games of chance in which primary and secondary game play can be operated cooperatively or independently of each other and which allows wagering on each option.

As indicated, card games such as black jack and Baccarat are well known in table gaming environments. Baccarat is a card game, played at casinos on which players can make wagers as various outcomes. The overwhelming majority of casino baccarat games in the United States, United Kingdom, Canada, Australia, Sweden, Finland, and Macau, are “Punto banco” baccarat. In Punto banco, the casino banks the game at all times, and commits to playing out both hands according to fixed drawing rules, in contrast to more historic baccarat games where each hand is associated with an individual who makes drawing choices. Player (“Punto”) and Banker (“banco”) are simply designations for the two hands dealt out in each coup, two outcomes which the punter can back.

There are three popular variants of the game: punto banco (or “North American baccarat”), baccarat chemin de fer, and baccarat banque (or “a deux tableaux”). Punto banco is strictly a game of chance, with no skill or strategy involved. Each player's moves are forced by the cards the player is dealt. In baccarat chemin de fer and baccarat banque, by contrast, both players can make choices, which allows skill to play a part. Despite this, the winning odds are in favour of the bank, with a house edge no lower than around 1 percent. Baccarat is a comparing card game played between two hands, the “player” and the “banker.” Each baccarat coup has three possible outcomes: “player” (player has the higher score), “banker,” and “tie.”

There are just two principal bets to make: banker or player—Banco or Punto, plus the rarely used Standoff. In online Baccarat the cards are dealt automatically by a virtual dealer. Each player, including the player dealing, may bet on either Punto or Banco but it is customary for the dealer to bet on Banco. Two hands are dealt and a player bets which one will win, or that they will tie. It is like betting on Black or Red at roulette, and the payoff is even money, 1:1 (except for the standoff, which pays 8-1 or 9-1). The only difference between the Banco and Punto bet is a win on Banco will cost the player 5% commission or tax levied by the casino. Over an 8-deck cards play on average the Banco will win three to four hands more than the Punto. Each hand consists of a minimum of two and a maximum of three cards. The person dealing will put two cards, face down and give the player with the largest bet on Punto the other two cards, face down. The Punto player then looks at the cards and gives them back to the player who is dealing. Then the player who is dealing will turn over the cards of both hands while one of the casino dealers will announce the results and the winner.

If either hand has a total of 8 or 9 (nine is the highest), then it is called a ‘Natural’ and no more cards are dealt. If it is not a natural, then depending on the value of each hand the casino dealer may instruct the card dealer to deal a third card. The decision when to deal a third card follows precise set rules used by all casinos. Once dealing is completed, the hand with the highest count wins. The paying casino dealers will collect the losing bets first and then pay the winning ones.

According to baccarat rules, Baccarat is played from a six-deck or an eight-deck shoe. All face cards and 10s have no value. Cards less than 10 are counted at face value, Aces are worth 1. Suits don't matter. Only single digit values are valid. Any count that reaches a double digit drops the left digit. 15 is counted as 5 and 25 is also counted as 5. To start, the players bet either on Banco or Punto or Standoff. The card dealer gives two cards each; first to the player and then the banker. The object of the game is to bet on the hand that the player thinks will have the highest total value. A third card may be dealt to either or both the player (Punto) and the bank (Banco) based on the following three-card-rules.

### Player's Third-Card-Rule.

If either the player or the bank have a total of 8 or 9 on the first two cards no further cards are drawn. The resulting hand is called a natural and the hand is over. If the player's total is less than or equal to 5 the player's hand draws a third card. If the player does not draw a third card, then the bank's hand stands on 6 or more and takes a third card on a total of 5 or less. If the player does take a third card then the Bank's third-card-rule below will determine if the bank takes a third card.

### Bank's Third-Card-Rule

If the bank's total is 2 or less, then bank draws a card, regardless of what the players third card is. If the banks total is 3 then the bank draws a third card unless the players third card was an 8. If the banks total is 4 then the bank draws a third card unless the players third card was a 0, 1, 8, or 9. If the banks total is 5 then the bank draws a third card if the players third card was 4, 5, 6, or 7. If the banks total is 6 then the bank draws a third card if the players third card was a 6 or 7. If the banks total is 7 then the bank stands.

House Advantage

Banker (Banco) 1.17%

Player (Punto) 1.36%

Tie (Standoff) 14.12% at 8:1 payout

### Valuation of Hands

In Baccarat, cards 2-9 are worth face value, 10s and J, Q K are worth zero, and Aces are worth 1 point. Hands are valued according to the rightmost digit of the sum of their constituent cards: for example, a hand consisting of 2 and 3 is worth 5, but a hand consisting of 6 and 7 is worth 3 (the rightmost digit of the total, 13). The highest possible hand value is 9. In the game, a “Baccarat” refers to anything with a value of zero; in a hand of K, 4 and 6, the King is a “baccarat,” and the hand value is also “baccarat.”

Punto banco is dealt from a dealing shoe containing 4, 6 or 8 decks of cards shuffled together. If either Player or Banker or both achieve a total of 8 or 9 at this stage, the coup is finished and the result is: Player win, a Banker win, or tie. If neither hand has eight or nine, the drawing rules are applied to determine whether the Player should receive a third card. Then, based on the value of any card drawn to the player, the drawing rules are applied to determine whether the Banker should receive a third card. The deal is then finished, the outcome is announced and winning bets are paid out.

Player's Rule:

If Player has an initial total of 0-5, he draws a third card. If Player has an initial total of 6 or 7, he stands.

Banker's Rule:

If Player has only two cards, the Banker regards only his own hand and acts according to the same rule as the Player. That means the Banker draws a third card with hands 0-5 and stands with 6 or 7. If the Player drew a third card, the Banker acts according to the following more complex rules:
If Player drew a 2 or 3, the Banker draws with 0-4, and stands with 5-7.
If Player drew a 4 or 5, the Banker draws with 0-5, and stands with 6-7.
If Player drew a 6 or 7, the Banker draws with 0-6, and stands with 7.
If Player drew an 8, the Banker draws with 0-2, and stands with 3-7.
If Player drew an ace, 9, 10, or face-card, the Banker draws with 0-3, and stands with 4-7.

The casinos list these rules in a more easily remembered format as follows:
If the banker total is 2 or less then banker draws a card, regardless of what the player's third card is.
If the banker total is 3 then the bank draws a third card unless the player's third card was an 8.
If the banker total is 4 then the bank draws a third card if the player's third card was 2, 3, 4, 5, 6, 7.
If the banker total is 5 then the bank draws a third card if the player's third card was 4, 5, 6, or 7.
If the banker total is 6 then the bank draws a third card if the player's third card was a 6 or 7.
If the banker total is 7 then the banker stands.

A math formula equivalent to the drawing rules is: Take the value of Player's third card, counting 8 and 9 as −2 and −1. Divide by 2 always rounding down towards zero. (Thus −1, 0, 1 all round to zero when this division is done.) Add three to the result. If the Banker's current total is this final value or less, then draw; otherwise, stand.

The croupier will deal the cards according to the tableau and the croupier will announce the winning hand: either Player or Banker. Losing bets will be collected and the winning bets will be paid according to the rules of the house. Usually, even money or 1-1 will be paid on Player bets and 95% to Banker bets (even money with “5% commission to the house”). Should both Banker and Player have the same value at the end of the deal the croupier shall announce “egalité—tie bets win.” all tie bets will be paid at 8 to 1 odds and all bets on Player or Banker remain in place and active for the next game.

Because baccarat attracts wealthy players, a casino may win or lose millions of dollars a night on the game, and the house's fortunes may significantly affect the owning corporation's profit and loss. Smaller versions of the game are common in some casinos including Ez baccarat which is similar to regular baccarat with the exception of the following: The bank is always paid even money; except when the Banker wins with three cards that have a point total of seven, in which case it is a “push” or a “barred” hand. Super 6/Punto 2000 is a variation of punto banco where even money is paid on winning Banker bets (rather than 95%); except when Banker wins with 6, it is paid only 50% of the bet. This game goes under various names including “Super 6,” and “Punto 2000.” Another version, Chemin de fer was the original version of baccarat when it was introduced to France and is still the version that is popular there. Six decks of cards are used. Players are seated in random order, typically around an oval table; discarded cards go to the center. Play begins to the right of the croupier and continues counterclockwise. At the start of the game, the croupier and then all players shuffle the cards in play order. The croupier shuffles a final time and the player to his left cuts the deck.

Once play begins, one player is designated as the “banker.” This player also deals. The other players are “punters.” The position of banker passes counterclockwise in the course of the game. In each round, the banker wagers the amount he wants to risk. The other players, in order, then declare whether they will “go bank,” playing against the entire current bank with a matching wager. The banker deals four cards face down: two to himself and two held in common by the remaining players. The player with the highest individual wager (or first in play order if tied for highest wager) is selected to represent the group of non-banker players. The banker and player both look at their cards; if either has an eight or a nine, this is immediately announced and the hands are turned face-up and compared. If neither hand is an eight or nine, the player has a choice to accept or refuse a third card; if accepted, it is dealt face-up. If the player's hand exceeds the banker's hand when they are compared, each wagering player receives back their wager and a matching amount from the bank, and the position of banker passes to the next player in order. If the banker's hand exceeds the player's hand, all wagers are forfeit and placed into the bank, and the banker position does not change. If there is a tie, wagers remain as they are for the next hand.

Another version is Baccarat Banque. In Baccarat Banque the position of banker is much more permanent. On either side of the banker are the punters (ten such constituting a full table). Any player may “go bank,” the first claim to do so belonging to the punter immediately on the right of the banker; the next to the player on his left, and so on alternatively in regular order. If two players on opposite sides desire to “go bank,” they go half shares.

A player going bank may either do so on a single hand, in the ordinary course, or a cheval, i.e. on two hands separately, one-half of the stake being played upon each hand. The laws of baccarat are complicated and no one code is accepted as authoritative, the different clubs making their own rules.

Blackjack, also known as twenty-one, is a widely played casino banking game. Blackjack is a comparing card game between a player and dealer, which means that players compete against the dealer but not against any other players. Blackjack is played with one or more decks of 52 cards. The object of the game is to reach 21 points or to reach a score higher than the dealer without exceeding 21. The player or players are dealt an initial two card hand and add the total of their cards. Face cards (Kings, Queens, and Jacks) are counted as ten points. The player and dealer can count his own ace as 1-point or 11 points. All other cards are counted as the numeric value shown on the card. After receiving their initial two cards, players have the option of getting a “hit,” which means taking an additional card. In a given round, the player or the dealer wins by having a score of 21 or by having the highest score that is less than 21. Scoring higher than 21 (called “busting” or “going bust”) results in a loss. A player may win by having any final score less than 21 if the dealer busts. If a player holds an ace valued as 11, the hand is called “soft”, meaning that the player cannot go bust by taking an additional card; otherwise, the hand is “hard”. The dealer has to take hits until his cards total 17 or more points. (In some casinos, the dealer also hits on a “soft” 17, e.g. initial ace and six.) Players who do not bust and have a total, higher than the dealer, win. The dealer will lose if he or she busts, or has a lesser hand than the player who has not busted. If the player and dealer have the same point total, this is called a “push” and the player typically does not win or lose money on that hand. Many rule variations of blackjack exist. Since the 1960s, blackjack has been a high profile target of advantage players, particularly card counters, who track the profile of cards that have been dealt and adapt their wager and playing strategies accordingly. Other casino games inspired by blackjack include Spanish 21 and pontoon.

In none of the baccarat or black regimes described above is there a capacity of a player to wager on the outcome of a third card selection which is independent of a first dealt hand. Third card selections are known in the prior art but it has hitherto been unknown to provide a baccarat or black jack game in which primary and secondary wagers are operating concurrently or sequentially, co dependently on earlier hands or independently of earlier dealt hands.

### INVENTION

The present invention provides an alternative to the known card games such as baccarat and blackjack whereby a player can play a primary game and exercise bet options on a secondary or auxiliary game either separate from the primary game or in cooperation with the primary game. The present invention provides increased betting options and increases actual or perceived opportunities for a win during a primary game of chance. The invention also provides the above features in real (table gaming) or electronic form. The invention further provides a betting regime for allowing a player to bet on a third card which is dealt.

Throughout the specification a reference to Commission can be taken to mean the amount collected by the dealer. Dealer is a person or object which deals at least one card. A Hand can be taken to mean one or a set of cards that have been dealt to a banker or player in a round of play. Initial deal can be taken to mean only the first two cards dealt to the player when the first two cards to the banker have been dealt. A reference to a game in this description can be taken to mean any card game which is presented as a casino table game, on line, on a gaming machine, on a video display, iphone, ipad, smart phone, tablet or computer.

Auxiliary or secondary game can be taken to mean a supplementary game on which a player can place a wager after a game has commenced and irrespective of whether a player has placed a bet on the game before dealing of player or banker hands. A natural means a point total of eight or none for either the player hand or the banker hand in the initial deal. A reference to the term player pair or banker pair can be taken to mean that the first two cards of either the player hand, the banker hand form a pair. An example of this would be two of a number or two of a letter such as two 9's or two Q's. A reference to a Point total can be taken to be a total value of cards in a hand. A reference to the term Modes of play can be taken to mean a period of play commencing with the commencement of play and concluding when the dealer announces a result and if applicable connects losing wagers and pays winning wagers. A reference to tie can be taken to mean that both the player hand and the banker hand have the same point total at the end of a round of play.

In its broadest form the present invention comprises:

a method of playing a card game comprising the steps of:
a) dealing at least one player a first card;
b) dealing a banker a first card;
c) dealing said at least one player a second card forming a hand with the first player card;
d) dealing said banker a second card forming a hand with the first banker card
e) prior to dealing the above hands, placing a bet/wager on the first or second of said hands in favour o a player the banker, a pair or a tie;
f) depending upon the totals of the two card in the first hands allowing a player to receive a third card or allowing the banker to receive a third card;
g) prior to receiving the third card, placing a bet/wager on an outcome based on the effect of the player or banker's third card on the outcome;
h) determining a wins status from the outcome of the third card.

According to one embodiment the card game is Baccarat. According to another embodiment the card game is black jack. According to a preferred embodiment, if the banker draws cards totaling less than 6, the banker will be issued with a third card which he must take. If the Player draws cards totaling less than 6, the player will be issued with a third card which he must take.

According to a preferred embodiment, if the two cards drawn by player total less than 6 and the banker draws two cards totaling 6 or 7, then a third card will be issued to the player. The player must accept this card and the banker must stand on 6 or 7. Prior to the dealing of the third card to the player, an opportunity exists to place a second (double up) bet on either the player or the banker. The third card deal is compulsory once first hand criteria are met.

In its broadest form the present invention comprises:

a game of cards in which a player is allowed a bet/wager on the effect of a third card dealt after predetermined criteria are met on a first hand dealt to a banker and/or player.

According to one embodiment the card game is baccarat. According to an alternative embodiment the card game is Black Jack. According to a preferred embodiment the dealing of the third card to the banker or player allows an opportunity to a player to place a first or second bet on the outcome of the effect of the third card whether the third card is dealt to the player or banker. According to one embodiment a player may decide not to participate in a wager on the first hand but may elect to bet on the second or auxiliary hand including the third card.

In another broad form the present invention comprises:

a card game in which at least one player and banker are dealt a first hand and contingent upon the outcome of the first hand and subject to the first hand meeting game criteria, a player or banker wagers on a hand which includes a third card dealt to either the banker or player subject to game criteria being met but irrespective of whether a wager is placed on said first hands by a player or banker.

According to one embodiment the card game is baccarat. According to an alternative embodiment the card game is Black Jack. According to a preferred embodiment if game criteria based on the first hand are met a compulsory third card is dealt, prior to which a player or banker has the opportunity to bet on the effect of the third card on the second hand.

The present invention provides an alternative to the known prior art and the shortcomings identified. The foregoing and other objects and advantages will appear from the description to follow. In the description reference is made to the accompanying representations, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying illustrations, like reference characters designate the same or similar parts. The following detailed description is, therefore, not to be taken in a limiting sense, and the scope of the present invention is best defined by the appended claims.

### BRIEF DESCRIPTION OF DRAWINGS

The invention will now be described in more detail according to a preferred but non limiting embodiment and with reference to the accompanying illustration.

FIG. 1 shows a plan view of a BAACARAT table layout according to a preferred embodiment.

FIG. 2 shows a plan view of a player zone of a baccarat table including a double up zone for banker and player.

FIG. 3 shows a table of odds for a player and a table of odds for a banker.

FIG. 4 shows a baccarat Table of play/Tableau.

FIG. 5 shows sample game dividends for banker and player wins.

FIG. 6 shows wins for every $100 bet for banker and player wins.

FIG. 7 shows a table of player and banker win percentages.

FIG. 8 shows a table of theoretical margins for double up betting and a blackjack perfect pair analysis using 8 decks.

### DETAILED DESCRIPTION

The invention will be described with reference to the card games of Baccarat and Black Jack. However, it will be appreciated that the invention can be adapted to alternative card games. It will be further appreciated that although the invention will be described with reference to table games such as is found in casinos, the invention is adaptable to on line gaming including on line card games.

With reference to the game of Baccarat, there are provided eight decks of 52 cards without jokers and having the same colour and design. Preferably the game is played on a table having a layout which provides various areas for player and banker wagers. A separate area is provided for the placement of double up player or banker wagers. It will be appreciated the table arrangement described can be adapted for on line game play including play on an electronic device such as an iphone, smart phone, ipad, computer, tablet, television, smart television or a device integrating any two of the aforesaid electronic devices. The game feature according to the invention is also adaptable to a gaming machine. The game feature will primarily be described with reference to a casino or gaming house table based game the game feature.

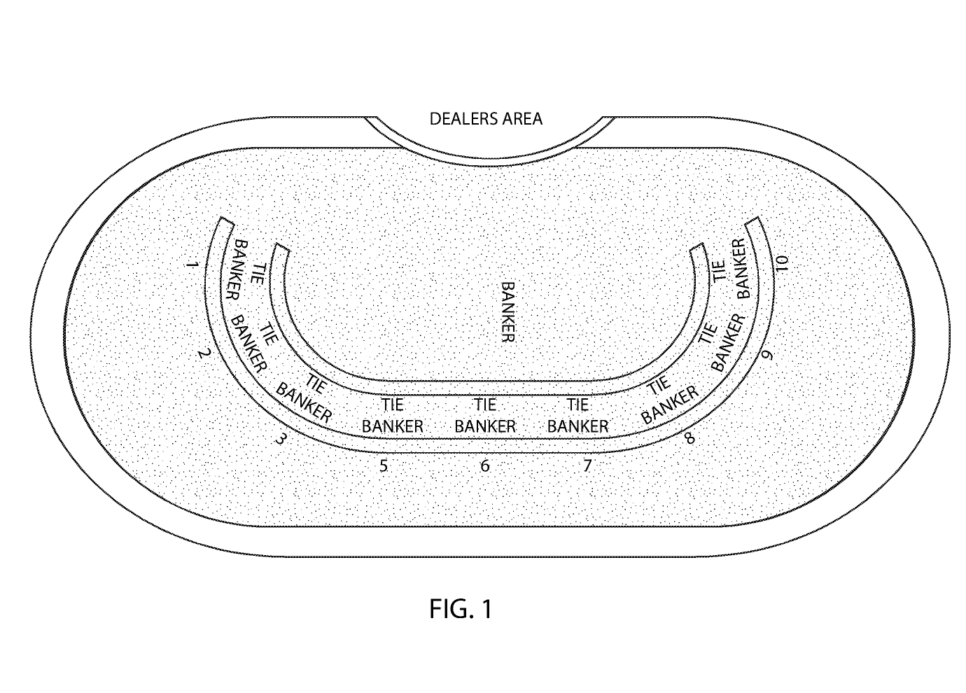

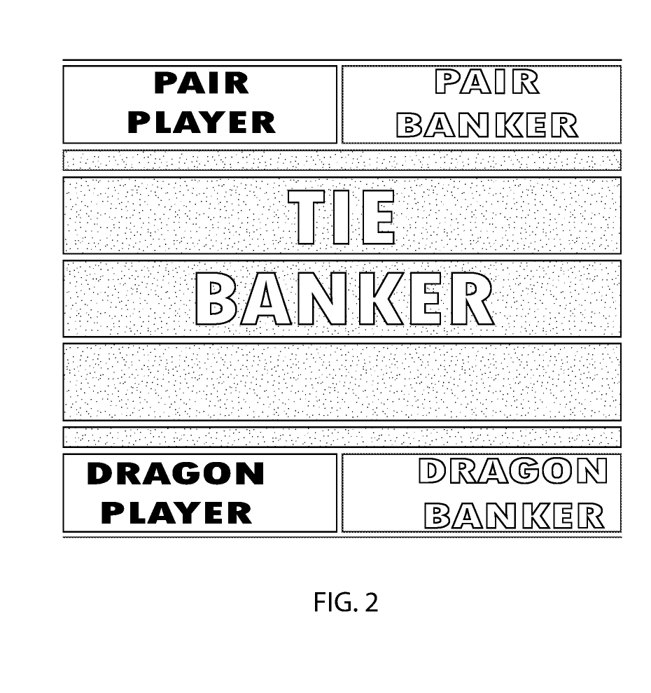

FIGS. 1 and 2 show baccarat tables in alternative forms on which the game regimes according to the invention may be played in casino environments. Referring to FIG. 1 there is shown shows a plan view of a BAACARAT table layout according to a preferred embodiment. Table 11 has regions normally found on a Baccarat table including a dealing area 12 and player and banker area 13. Playing area 13 is divided into various play areas identified by the numerals 1-10. Each play area is dedicated to one player and is divided into the regions shown in FIG. 2. FIG. 2 shows a plan view of play area 6 of a baccarat table 11. Area 6 comprises zone 15 pair player, zone 16 pair banker, zone 17 tie, zone 18 banker, zone 19 player.

### Game Methodology

Game play for Baccarat is commenced by a dealer inviting a player to place a bet. Once betting has closed cards can be dealt. Cards are valued as follows: cards numbered from 2-9 inclusive have as their point value the face value of the cards. An Ace is valued as one. Each Jack Queen, King or Ten has a point value of 9 or zero. The point total of a hand shall be as follows: where the total value of the cards in a hand is a number between zero and nine the point total shall be that number. Alternatively, where the total value of the cards in the hand is the number ten or a higher number, the point total shall be the right digit of that number only. Banker, Player, Pair and Tie Baccarat wagers are independent wagers and may be played in combination or individually. Two hand are dealt one of which is a player hand and the other of which is the bankers hand.

Four cards are dealt from the dealing shoe with the first and third cards dealt representing the first and second cards of the player hand and the second and fourth cards dealt representing the first and second cards of the banker hand. Those four cards determine the outcome of pair wagers. Player pair wagers win if the first two cards of the player hand constitute a pair and banker pair wagers win if the first two cards of the of the banker hand constitute a pair. Following announcement of the point total of each hand after the initial four cards are dealt, a third card shall be dealt if so required pursuant to the table of play. A third card to player or banker or to player and banker. A double up baccarat gaming opportunity at odds for pursuant to table of play and table of odds.

According to one embodiment of the invention a player is dealt the first card, followed by one to the banker. A second card is then dealt to the player followed by second card to the banker. These four cards form the initial hand and first bets can be placed prior to dealing. Bets at this point can be placed on player, banker, tie or pairs according to conventional methodology. Ace counts as one. Tens and all picture cards count as zero as per usual criteria.

If the two cards drawn by either player or banker total 8 or 9, this is called a natural and no further card will be issued on the game. If both player and banker have a total of 9, this is deemed a tie. Bets placed on the tie would be paid at 8 to 1. Bets placed on player or banker are refunded. Bets placed on pairs are forfeited.

If player totals 9 and the banker totals 8, the player wins. If player totals 8 and the banker totals 9, the banker wins. If player and the banker total 8, this game is deemed a tie and all bets placed on player or the banker are refunded. IF the 8 is made up of 2× fours in either or both hands, pairs will be paid at 11 to 1. If the two cards drawn by the player total 7, the player must stand and no third card will be issued to player. If the banker draws cards totaling less than 6, the banker will be issued with a third card which he must take. The double up draw on the third card is once relevant criteria are satisfied compulsory.

Currently there is no regime to allow betting on an outcome generated by the dealing of the third card. Prior to the dealing of the third card to the banker, an opportunity is provided to a player to place a second bet (irrespective of whether the player has bet on the outcome of the primary game—i.e. dealing of the first two cards) on the outcome of the effect of the third card whether the third card is dealt to the player or banker. Any bets on the initial hand or primary game will stand and can be made independent of the outcome of the secondary betting on the third card or contingent upon the outcome of the betting on the first two cads. The betting regime can be adjusted as required within the framework of the original bet if made or at least as a consequence of the initial card deal to player or banker.

If the two cards drawn by the player total 6, the player must stand and no third card will be issued to the player. If the banker draws 7, the banker wins. If the banker draws 6, tie will be paid at 8 to 1. The player and the banker bets will be refunded if the tie is paid.

If the two cards drawn by the player total less than 6 and the banker draws two cards totaling 6 or 7, then a third card will be issued to the player. The player must accept this card and the banker must stand on 6 or 7. Prior to the dealing of the third card to the player, an opportunity exists to place a second (double up) bet on either the player or the banker. Initial bets stand. If the player and the banker draw cards totaling less than 6, both the player and the banker will receive and must accept a third card. Prior to the dealing of these third cards, an opportunity exists to place a second (double up) bet on either the player or the banker. Initial bets stand.

If the player draws two cards of the same denomination (eg 2×2, 2×KING, 2×ACE), then the player pair bets will be paid at 11 to 1, irrespective of the final outcome of the game. If the banker draws to cards of the same denomination (eg 2×2, 2×6, 2×10), then the banker pair bets will be paid at 11 to 1, irrespective of the final outcome of the game. If both the player and the banker draw two cards of the same denomination, then both the player and the banker pair bets will be paid at 11 to 1, irrespective of the final outcome of the game. Pairs do not affect this issuing of third cards when appropriate. This second bet allows patrons to make a more informed decision for investment in the game.

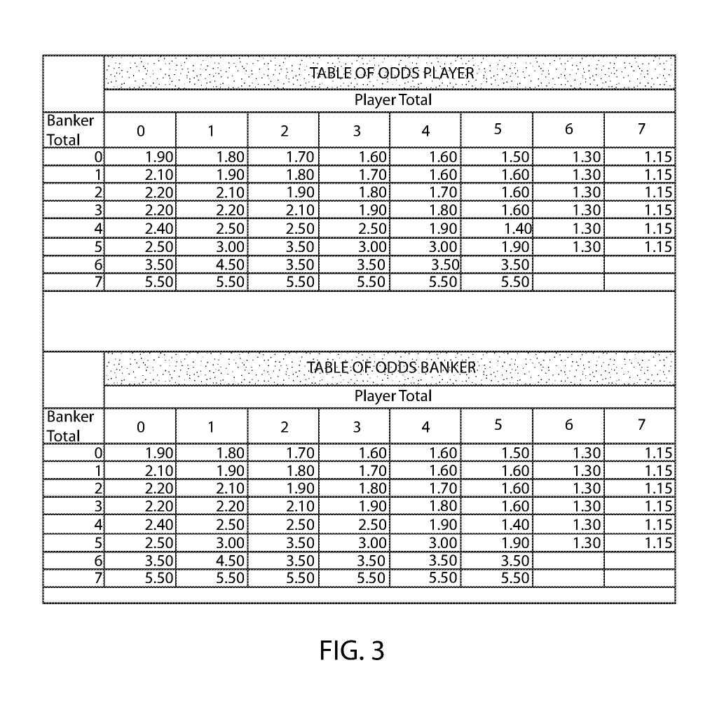

The above described game play methodology and third card betting regime according to the invention in all its forms, is also adaptable to on line and internet gaming, gaming on electronic hand held devices and on devices such as computers, ipads, iphones and gaming machines. In each case the game rules may be altered to suit regulatory requirements or device capability provided each allows the capacity for a player to wager on a third card separately or in addition to a previously laid wager on a first hand of two cards. FIG. 3 shows a table of odds for a player and a table of odds for a banker.

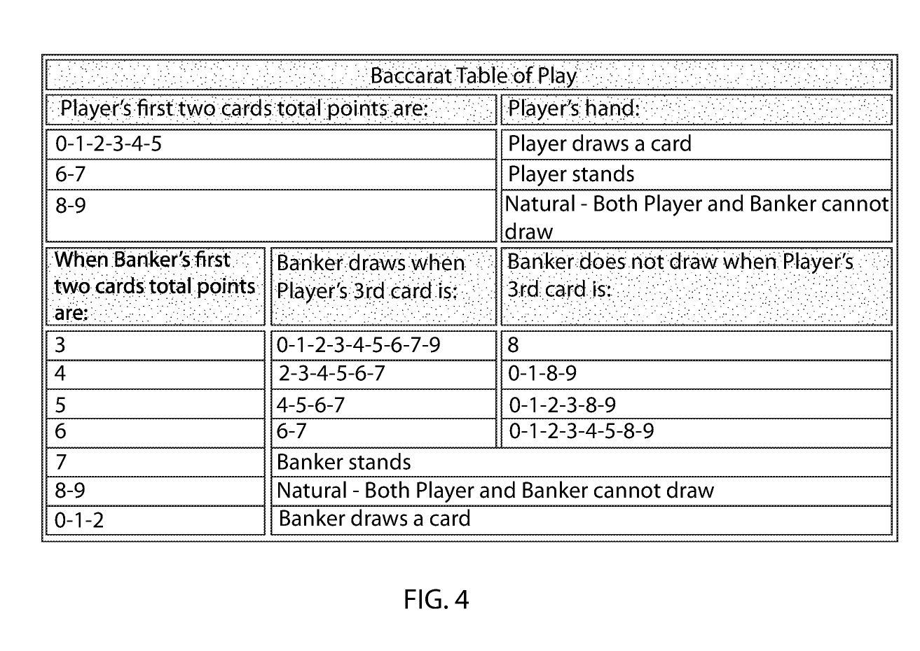

FIG. 4 shows a baccarat table of play. If the point of the player hand or the banker hand after the initial four cards are deal is 8 or 9 which is called a natural no more cards shall be dealt to either hand. When the player has: player draws a card, player stands, natural—no cards are drawn to either hand, when the player stands the banker draws on 0-5 and stands on 6 or 7. When the banker has: banker draws when the player third card has a point value of 0-9. Banker draws when the player third card has a point value of 0-9, except for 8. Banker draws when the player third card has a point value of 2-7.

Banker draws when the player third card has a point value of 4-7. Banker draws when the player third card has a point value of 6 or 7. Banker stands at other times. The winner of the round play is the hand with the highest point total, the round of play is a Tie the initial wagers on player and banker so not win or lose in the case of the Tie and all Tie wagers win.

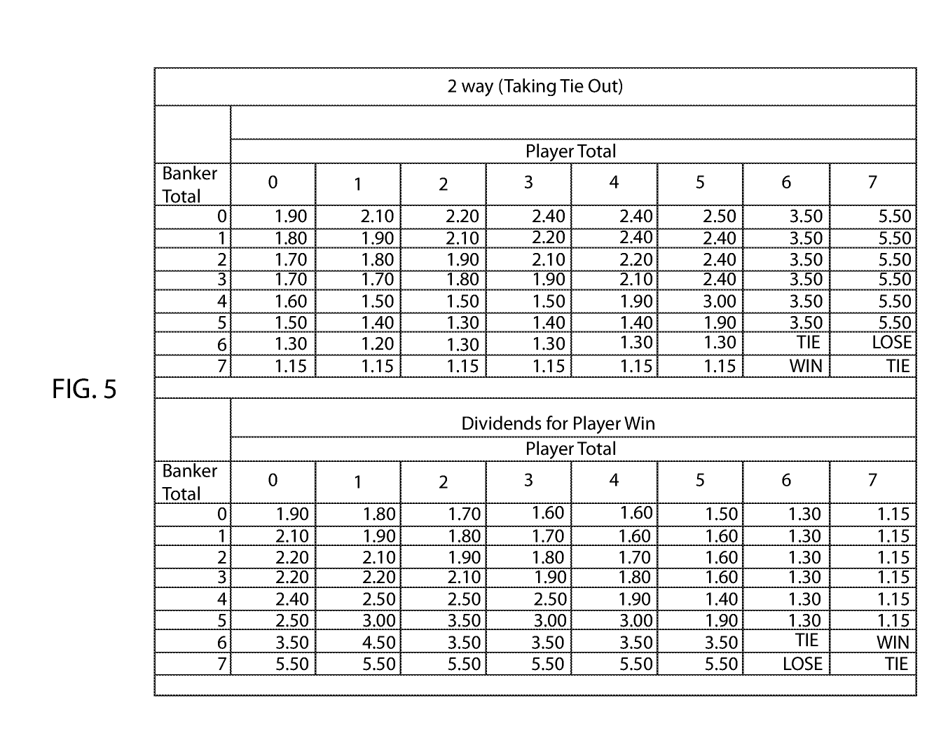

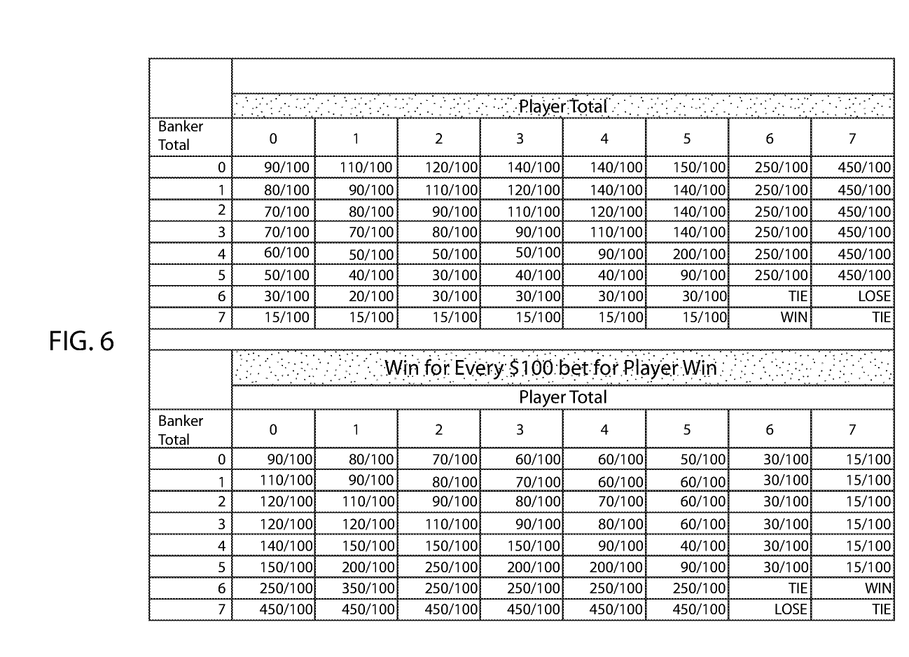

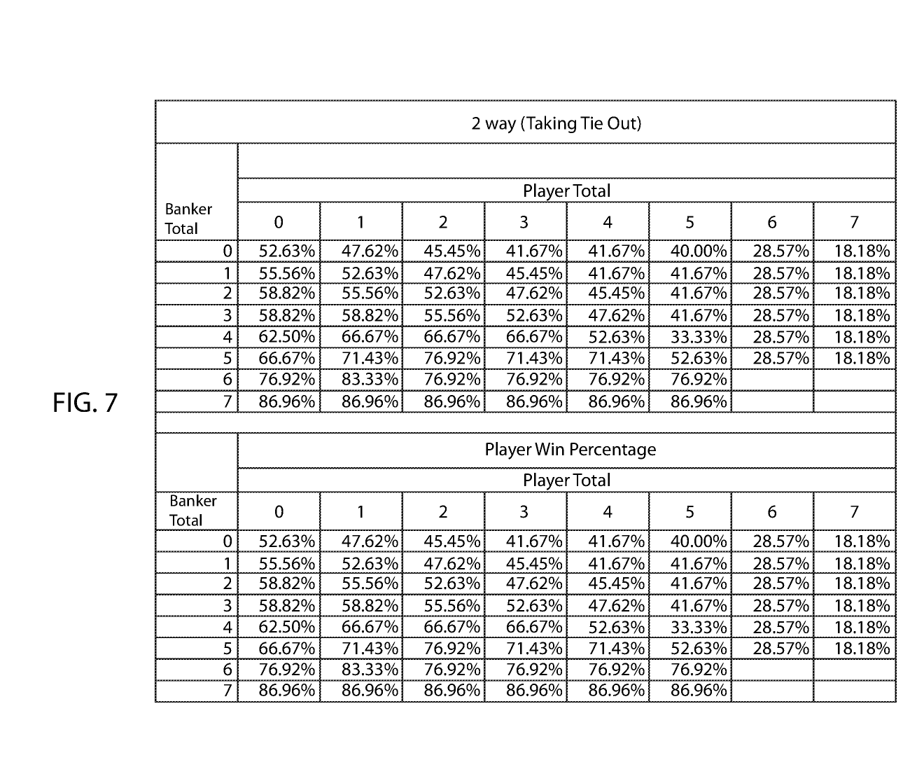

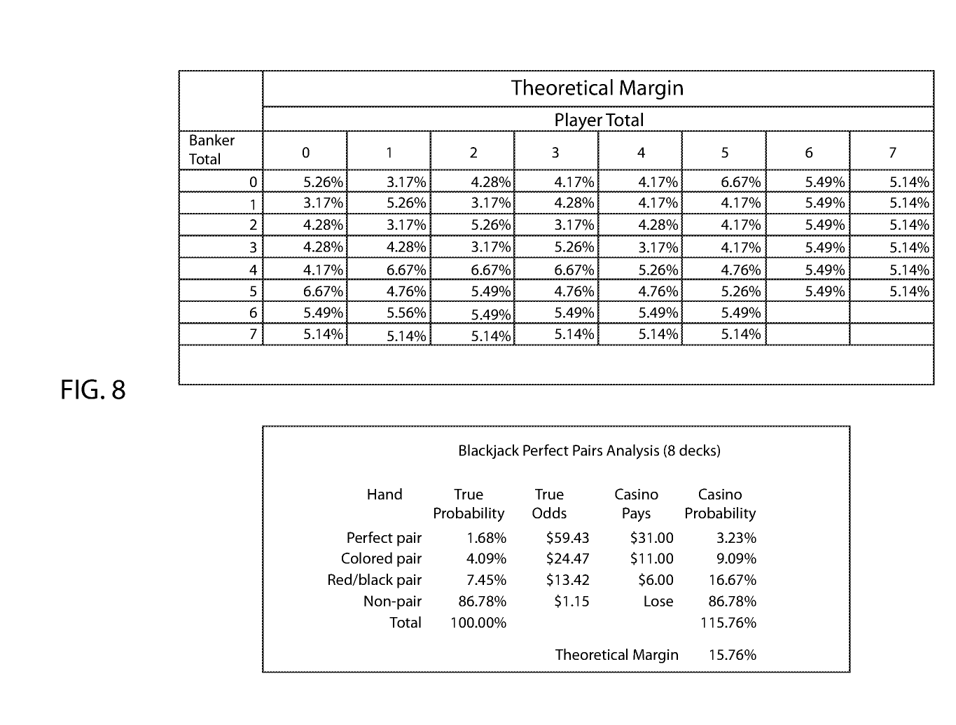

The game feature according to the invention described herein allows a wager where the table of play after the Player and banker have been dealt two cards each and the scores are displayed. Either player or banker are able to make a wager by the table of play and a wager by the set of odds for either player of banker. The table of play allows the player to enter and wager on options after game play has commenced thereby increasing the chance of a win or a perceived increase in the chances of a win. FIG. 5 shows sample game dividends for banker and player wins. FIG. 6 shows wins for every $100 bet for banker and player wins. FIG. 7 shows a table of player and banker win percentages. FIG. 8 shows a table of theoretical margins for double up betting and a blackjack perfect pair analysis using 8 decks.

Black jack wagering option; there is a chance that the dealer will not bust so odds could be say a $1.40 to get between 17 and 21 and odds of $3.00 to bust (dealer must stand on 17 or over). Another example would be if the dealer gets a hand with a 6 face up. In this instance there is a strong chance for the dealer to bust and hence the odds could be reversed to say 1.50 to bust and $2.50 to get between 17 and 21.

At a casino blackjack table, the dealer typically faces five to seven playing positions from behind a semicircular table. Between one and eight French decks of cards are shuffled together. At the beginning of each round, up to three players place their bets in the “betting box” at each position in play. Each box is dealt an initial hand of two cards visible to the people playing on it, and often to any other players. The dealer's hand receives its first card face up, and in “hole card” games receives its second card face down immediately (the hole card), which the dealer peeks at but does not reveal unless it makes the dealer's hand a blackjack. Cards are dealt either from one or two hand-held decks, from a dealer's shoe, or from a shuffling machine. Single cards are dealt to each of wagered-on position clockwise from the dealer's leftmost position, followed by a single card to the dealer, followed by an additional card to each of the positions in play. The players' initial cards may be dealt face-up, or face-down.

The players' object is to win money by creating card totals which will turn out to be higher than the dealer's hand, but without exceeding 21 (“busting”/“breaking”). On their turn, players must choose whether to take a card, “stand” (end their turn), “double” (double wager, take a single card and finish), “split” (if the two cards have the same value, separate them to make two hands) or “surrender” (give up a half-bet and retire from the game).

Number-cards count as their natural value; the jack, queen, and king (also known as “face cards” or “pictures”) count as 10; aces are valued as either 1 or 11 according to the player's choice. If the hand value exceeds 21 points, it busts, and all bets on it are immediately forfeit. After all boxes have finished playing, the dealer's hand is resolved by drawing cards until the hand busts or achieves a value of 17 or higher (a dealer total of 17 including an ace, or “soft 17”, must be drawn to in some games and must stand in others). The dealer never doubles, splits nor surrenders. If the dealer busts, all remaining player hands win. If the dealer does not bust, each remaining bet wins if its hand is higher than the dealer's, and loses if it is lower. In the case of a tied score, known as “push” or “standoff”, bets are normally returned without adjustment; however, a blackjack beats any hand which is not a blackjack, even with value 21. Blackjack vs. blackjack is a push. Wins are paid out at 1:1, or equal to the wager, except for winning blackjacks, which are traditionally paid at 3:2 (meaning the player receives three dollars for every two bet), or one and a half times the wager. Blackjack games provide a side bet called insurance, which may be played when dealer's upcard is an ace.

In the game of blackjack a wager option is superimposed on the game play by allowing a player an option of wagering on a hand once game play has commenced. A player may elect not to wager on a first hand dealt to the player or banker. The player may opt to bet in running after a banker has for instance been dealt a bad card. If the banker receives a good card the player can elect not to bet. The player can have had an initial bet but may also bet on the run during the game. Alternatively the player may refrain from betting on an initial hand but elect to be in a secondary or auxiliary bet on another hand created by dealing additional card/s during game play. The secondary betting option is in additional to the known bet options described earlier.

The tables below Find attached a spreadsheet with the recommended odds worked to approximately 5% theoretical margin and rounding of odds for casino play—after which I have settled on the odds shown in the tables. I have also worked on the payouts on $100 bet as well which is below the dividend odds.

The theoretical margin ranges from just over 3% to around 6%. Also included are percentages of Perfect Pairs in blackjack. The casino has in this analysis over 15% margin in its favour. Margins around 6% are acceptable to casinos. The sample dividends to whole numbers or 50c. Anything above $2.50 only is in increments of 50c. There may in practice be higher interest in odds below $1.50 and above $2.50, as it is likely that punters will let their original bets ride when odds are displayed between a $1.50 and $2.50.

It will be recognised by persons skilled in the art that numerous variations and modification may be made to the invention broadly described herein without departing from the overall spirit and scope of the invention.

1. A method of wagering on a card game in which at least one player's first hand and a banker's first hand are dealt, the at least one player's first hand and the banker's first hands each comprising at least two cards, the method comprising the steps of:
a) prior to dealing of said hands, a player elects to wager or not to wager on one or both said hands based on none of the first hand cards being revealed,
b) revealing at least one of the cards or both of the cards in each first hand;
c) dealing at least a third card to form a new hand on which a player is able to place a bet/wager on the effect of said third card dealt irrespective of whether or not the player wagered on said first hands.

2. A method of wagering on a card game, according to claim 1 wherein, the wager on the third card provides a secondary bet/wager option for a player during game play.

3. A method of wagering on a game according to claim 2 wherein the secondary bet option is available to a player after commencement of the game.

4. A method of wagering on a game according to claim 3 comprising the further step of making the secondary bet option is available during game play once predetermined game criteria are met on first hands of cards dealt to a banker and/or player.

5. A method of wagering on a game according to claim 4 wherein said first player and banker's hands each comprise two dealt cards.

6. A method of wagering on a game according to claim 5 comprising the further step of prior to exercise of said secondary bet option one of the two cards of the player or banker's hand is made viewable to the player.

7. A method of wagering on a game according to claim 6 comprising the further step of providing a table of play of betting odds associated with the game after the game has commenced is displayed for the player and banker.

8. A method of wagering on a game according to claim 7 comprising the further step of displaying the table of play of betting odds is displayed after the Player and banker have been dealt two cards each.

9. A method of wagering on a game according to claim 8 comprising the further step of displaying scores on the table of play.

10. A method of wagering on a game according to claim 9 comprising the further step of allowing either a player or the banker to make a wager using said secondary bet option according to the table of play and by betting odds for either player or banker.

11. A method of wagering on a card game comprising the steps of:
a) dealing at least one player a first card;
b) dealing a banker a first card;
c) dealing said at least one player a second card forming with the first card a player hand;
d) dealing said banker a second card forming a hand with the first banker card
e) depending upon the totals of the two cards in the first hands allowing a player to receive a third card or allowing the banker to receive a third card;
f) prior to receiving the third card, allowing the player or banker to place a first bet/wager on an outcome based on the effect of the player or banker's third card on the outcome of a hand including the third card; and
g) determining a win or loss status from the outcome of the third card.

12. A method according to claim 11 comprising the further step of
a) prior to dealing the first banker hand and player hands, placing a bet/wager on the first banker or player hands in favour of the outcomes on one or more of a player hand, a banker hand, a pair or a tie.

13. A method according to claim 12 comprising the further step of issuing the, the banker with a third card which the banker must take.

14. A method according to claim 13 wherein, if a player draws cards totaling less than 6, the player is issued with a third card which the player must take.

15. A method according to claim 14 comprising the further step of conducting a banker draw in which a banker draws cards totaling less than 6.

16. A method according to claim 15 comprising the further step of:
allowing a player to draw two cards whereupon if the two cards drawn by the player total less than 6 and the banker draws two cards totaling 6 or 7, then a third card is issued to the player.

17. A method according to claim 16 comprising the further step prior to the dealing of the third card to the player, but after commencement of the game allowing the player to place a second (double up) bet on either the player or the banker.

18. A method according to claim 17 wherein the third card dealt for creating a new player or banker hand is compulsory once a first-hand criteria are met.

19. A method according to claim 18 wherein the player must accept the third card and the banker must stand on a card total of 6 or 7.

20. A method according to claim 19 wherein, dealing of the third card to the banker or player allows an opportunity for a player to place a first or second bet on the outcome of the effect of the third card whether the third card is dealt to the player or banker.
